(19) United States
(12) Patent Application Publication
(10) Pub. No.: US 2017/0204218 A1
(43) Pub. Date: Jul. 20, 2017

(54) Water-Vapour Permeable Composite Parts

(71) Applicant: Covestro Deutschland AG, Leverkusen (DE)

(72) Inventors: Govert Woeste, Düsseldorf (DE); Franz-Heinrich Hermanns, Grevenbroich (DE)

(21) Appl. No.: 15/324,599

(22) PCT Filed: Jul. 6, 2015
(86) PCT No.: PCT/EP2015/065282

§ 371 Date: Jan. 6, 2017

(30) Foreign Application Priority Data
Jul. 11, 2014 (EP) 14176711.1

(51) Int. Cl. C08G 18/48; B05D 3/02; B29B 9/06; B29C 47/00; E04D 5/06; C08G 18/10; C08G 18/76; C08G 18/32; C08J 5/18; E04B 1/62; B05D 1/30; C08G 18/24

(52) U.S. Cl. CPC C08G 18/48; B05D 1/30; B05D 3/0254; B29B 9/065; B29C 47/0004; B29C 47/0021; C08G 18/244; C08G 18/10; C08G 18/7671; C08G 18/3206; C08J 5/18; E04B 1/625; E04D 5/06; B29K 2075/00

(57) ABSTRACT

The invention relates to water-vapour permeable, flat composite parts consisting of at least two layers, at least one layer being made of a particular wax-containing thermoplastic polyurethane. The invention also relates to the use thereof.

The invention relates to water vapour-permeable flat composite components consisting of at least two layers, wherein at least one layer consists of a thermoplastic polyurethane containing particular waxes, and to the use thereof.

Thermoplastic polyurethane elastomers (TPUs) are of industrial significance, since they exhibit excellent mechanical properties and can be processed by thermoplastic means inexpensively. Through the use of different chemical formation components, it is possible to vary their mechanical properties over a wide range. Comprehensive descriptions of TPUs, and the properties and uses thereof, can be found in Kunststoffe 68 (1978), p. 819-825 and Kautschuk, Gummi, Kunststoffe 35 (1982), p. 568-584.

TPUs are formed from linear polyols, usually polyester or polyether polyols, organic diisocyanates and short-chain diols (chain extenders). The formation reaction can be accelerated by additionally adding catalysts. The molar ratios of the formation components can be varied over a wide range, which allows the properties of the product to be adjusted. According to the molar ratios of polyols to chain extenders, products are obtained over a wide Shore hardness range. The thermoplastically processible polyurethane elastomers can be formed either stepwise (prepolymer method) or through the simultaneous reaction of all the components in one stage (one-shot method). In the prepolymer method, the polyol and diisocyanate are used to form an isocyanate-containing prepolymer which is reacted in a second step with the chain extender. The TPUs can be prepared continuously or batchwise. The best-known industrial production methods are the belt method and the extruder method.

As well as catalysts, auxiliaries and additives can also be added to the TPU formation components. One example is waxes, which assume important tasks both in the industrial production of the TPUs and in the processing thereof. The wax serves as a friction-reducing internal and external lubricant and improves the flow properties of the TPU. In addition, it is supposed to prevent the sticking of the TPU to the surrounding material (for example the mould) as a separating agent, and to act as a dispersant for other additives, for example pigments and antiblocking agents.

The prior art mentions, for example, fatty acid esters such as stearic esters and montanic esters and metal soaps thereof, fatty acid amides such as stearylamides and oleamides, and polyethylene waxes as waxes to be used. An overview of the waxes used in thermoplastics can be found in H. Zweifel (ed.): Plastics Additives Handbook, 5th edition, Hanser Verlag, Munich 2001, p. 443ff.

In TPUs, essentially amide waxes having a good separating action, especially ethylenebisstearylamide, have been used to date. Derivatives based thereon, for example reaction products of alkylenediamines with 12-hydroxystearic acid, are mentioned in EP-A 1826225 because of their particularly low migration tendency. In addition, montan ester waxes which exhibit good lubricant properties combined with low volatility are used (EP-A 308 683; EP-A 670 339; JP-A 5 163 431). Ester and amide combinations (DE-A 19 607 870) and specific wax mixtures of montanic acid and fatty acid derivatives (DE-A 19 649 290) are likewise used.

These waxes show good separating agent properties and less formation of deposits at the surface of the thermoplastic products containing these waxes.

For the use of flat composite components or films of TPU in the construction sector or in high-quality textiles, the flat composite components must especially have good water vapour permeability. In addition, the flat composite components should have a maximum lifetime with simultaneous retention of the good water vapour permeability.

The problem addressed in the present application was that of providing flat composite components which are not just water vapour-permeable but also have good water vapour permeability maintained over a maximum period of time, especially under the external influences during the construction phase.

This problem was surprisingly solved by the inventive flat composite components composed of at least two layers, of which at least one layer consists of thermoplastic polyurethane containing specific waxes.

The present invention provides water vapour-permeable, flat composite components consisting of at least two layers, where at least one layer consists of a thermoplastic polyurethane obtainable from the reaction of the components consisting of

A) one or more organic diisocyanates,

B) one or more components each having two hydroxyl groups and a number-average molecular weight of 60 to 490 g/mol as chain extenders,

C) one or more linear aliphatic hydroxyl-terminated polyether polyols each having number-average molecular weights of 500 to 5000 g/mol and a number-average functionality of component C) of 1.8 to 2.5,

D) optionally polyester polyols each having number-average molecular weights of 500-5000 g/mol and a number-average functionality of component D) of 1.8 to 2.5, where the molar ratio of the NCO groups in A) to the isocyanate-reactive groups in components B) and C) and optionally D) is 0.9:1 to 1.2:1, in the presence of

E) optionally catalysts, with addition of

F) optionally auxiliaries and/or additives, characterized in that the reaction is effected with addition of

G) 0.02% to 3% by weight, preferably 0.02% to 1.0% by weight, based on the overall thermoplastic polyurethane, of at least one component from the group consisting of
i) maleic anhydride-grafted polyolefins, preferably maleic anhydride-grafted polyethylenes,
ii) diesters of branched diols which may contain further hydroxyl groups with mixtures of linear or branched, saturated or unsaturated mono- and dicarboxylic acids, where the linear or branched, saturated or unsaturated mono- and dicarboxylic acids are optionally used in a stoichiometric excess, preferably diesters of adipic acid, oleic acid and pentaerythritol,
iii) mixtures of salts of linear or branched, saturated or unsaturated monocarboxylic acids and diesters of linear or branched, saturated or unsaturated monocarboxylic acids with linear diols, where the linear or branched, saturated or unsaturated monocarboxylic acids are optionally used in a stoichiometric excess,
iv) reaction products of alkylenediamines, preferably ethylenediamine, with 12-hydroxystearic acid,
v) reaction products of alkylenediamines, preferably ethylenediamine, with 12-hydroxystearic acid and one or more linear fatty acids, preferably stearic acid, and the water vapour permeability of the layer of the thermoplastic polyurethane decreases by not more than 10% after ageing at 70° C. over 24 hours.

The TPUs used in accordance with the invention surprisingly have very good water vapour permeabilities after ageing, and so it is thus possible to provide the composite components according to the invention.

Useful organic diisocyanates A) preferably include aliphatic, cycloaliphatic, araliphatic, heterocyclic and aromatic diisocyanates, as described in Justus Liebigs Annalen der Chemie, 562, p. 75-136.

Specific examples include: aliphatic diisocyanates such as hexamethylene 1,6-diisocyanate, cycloaliphatic diisocyanates such as isophorone diisocyanate, cyclohexane 1,4-diisocyanate, 1-methylcyclohexane 2,4-diisocyanate and 1-methylcyclohexane 2,6-diisocyanate and the corresponding isomer mixtures, dicyclohexylmethane 4,4′-diisocyanate, dicyclohexylmethane 2,4′-diisocyanate and dicyclohexylmethane 2,2′-diisocyanate and the corresponding isomer mixtures, aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and diphenylmethane 2,4′-diisocyanates, 4,4′-diisocyanato-1,2-diphenylethane and naphthylene 1,5-diisocyanate. Preference is given to using hexamethylene 1,6-diisocyanate, isophorone diisocyanate, dicyclohexylmethane 4,4′-diisocyanate, naphthylene 1,5-diisocyanate and diphenylmethane diisocyanate isomer mixtures having a diphenylmethane 4,4′-diisocyanate content of >96% by weight and especially diphenylmethane 4,4′-diisocyanate and hexamethylene 1,6-diisocyanate. These diisocyanates can be used individually or in the form of mixtures with one another. They can also be used together with up to 15% by weight (based on the total amount of diisocyanate) of a polyisocyanate, for example triphenylmethane 4,4′,4″-triisocyanate or polyphenylpolymethylene polyisocyanates.

Chain extenders B) used are one or more diols having a number-average molecular weight of 60 to 490 g/mol, preferably aliphatic diols having 2 to 14 carbon atoms, for example ethanediol, propanediol, butanediol, hexanediol, diethylene glycol, dipropylene glycol, especially butane-1,4-diol. Also suitable, however, are diesters of terephthalic acid with glycols having 2 to 4 carbon atoms, for example ethylene glycol bisterephthalate or butane-1,4-diol bisterephthalate, hydroxyalkylene ethers of hydroquinone, for example 1,4-di(beta-hydroxyethyl)hydroquinone and ethoxylated bisphenols, for example 1,4-di(beta-hydroxyethyl)bisphenol A. It is also possible to use mixtures of the aforementioned chain extenders, especially two different chain extenders, more preferably two different aliphatic chain extenders. In addition, it is also possible to add relatively small amounts of triols.

Components C) used are linear aliphatic hydroxyl-terminated polyether polyols having a number-average molecular weight of 500 to 5000 g/mol. For production reasons, these often contain small amounts of nonlinear compounds. They are therefore frequently also referred to as “essentially linear polyols”.

Suitable polyether polyols for component C) can be prepared by reacting one or more alkylene oxides having 2 to 4 carbon atoms in the alkylene radical with a starter molecule containing two active hydrogen atoms in bound form. Examples of alkylene oxide include: ethylene oxide, 1,2-propylene oxide, epichlorohydrin and 1,2-butylene oxide and 2,3-butylene oxide. Preference is given to using ethylene oxide, 1,2-propylene oxide and mixtures of 1,2-propylene oxide and ethylene oxide. The alkylene oxides can be used individually, in alternating succession or as mixtures. Examples of useful starter molecules include: water, amino alcohols such as N-alkyldiethanolamines, for example N-methyldiethanolamine, and diols such as ethylene glycol, 1,3-propylene glycol, butane-1,4-diol and hexane-1,6-diol. It is optionally also possible to use mixtures of starter molecules. Suitable polyether polyols are also the hydroxyl-containing polymerization products of propane-1,3-diol and tetrahydrofuran, and polyether polyols formed from ethylene oxide units and propylene oxide units. It is also possible to use trifunctional polyethers, but at most in such an amount as to form a thermoplastically processible product and such that the number-average functionality of the sum total of all the polyether polyols in C) is 1.8 to 2.5. The essentially linear polyether polyols have number-average molecular weights of 500 to 5000 g/mol. They can be used either individually or in the form of mixtures with one another. Preference is given to using one or more aliphatic polyether polyols from the group consisting of poly(ethylene glycol), poly(1,2-propylene glycol), poly(1,3-propylene glycol), poly(tetramethylene glycol) and polyether polyols formed from ethylene oxide units and propylene oxide units.

Suitable polyester polyols for component D) can be prepared, for example, from dicarboxylic acids having 2 to 12 carbon atoms, preferably 4 to 6 carbon atoms, and polyhydric alcohols. Examples of useful dicarboxylic acids include: aliphatic dicarboxylic acids such as succinic acid, glutaric acid, adipic acid, suberic acid, azelaic acid and sebacic acid, and aromatic dicarboxylic acids such as phthalic acid, isophthalic acid and terephthalic acid. The dicarboxylic acids can be used individually or as mixtures, for example in the form of a succinic acid, glutaric acid and adipic acid mixture. For preparation of the polyester polyols, it may in some cases be advantageous to use, rather than the dicarboxylic acids, the corresponding dicarboxylic acid derivatives such as carboxylic diesters having 1 to 4 carbon atoms in the alcohol radical, carboxylic anhydrides or carbonyl chlorides. Examples of polyhydric alcohols are glycols having 2 to 10 and preferably 2 to 6 carbon atoms, such as ethylene glycol, diethylene glycol, butane-1,4-diol, pentane-1,5-diol, hexane-1,6-diol, decane-1,10-diol, 2,2-dimethylpropane-1,3-diol, propane-1,3-diol and dipropylene glycol. According to the desired properties, the polyhydric alcohols may be used alone or optionally in a mixture with one another. Also suitable are esters of carbonic acid with the diols mentioned, especially those having 4 to 6 carbon atoms, such as butane-1,4-diol or hexane-1,6-diol, condensation products of hydroxycarboxylic acids, for example hydroxycaproic acid, and polymerization products of lactones, for example optionally substituted caprolactones. Polyester polyols used with preference are ethanediol polyadipate, butane-1,4-diol polyadipate, ethanediol butane-1,4-diol polyadipate, hexane-1,6-diol neopentyl glycol polyadipate, hexane-1,6-diol butane-1,4-diol polyadipate and polycaprolactones. The polyester polyols have number-average molecular weights of 500 to 5000 g/mol and can be used individually or in the form of mixtures with one another. Preference is given to using aliphatic polyester polyols.

Suitable catalysts E) for TPU production may be the customary tertiary amines known according to the prior art, for example triethylamine, dimethylcyclohexylamine, N-methylmorpholine, N,N′-dimethylpiperazine, 2-(dimethylaminoethoxy)ethanol, diazabicyclo[2.2.2] octane, and preferably organic metal compounds, for example titanic esters, iron compounds, tin compounds, for example tin diacetate, tin dioctoate, tin dilaurate or the dialkyltin salts of aliphatic carboxylic acids, for example dibutyltin diacetate, dibutyltin dilaurate. Particularly preferred catalysts are organic metal compounds, especially titanic esters, iron compounds or tin compounds.

As well as the TPU components and the catalysts, it is also possible to add other auxiliaries and/or additives F). Examples include silicone compounds, antiblocking agents, inhibitors, stabilizers against hydrolysis, light, heat and discolouration, flame retardants, dyes, pigments, inorganic or organic fillers and reinforcers. Reinforcers are especially fibrous reinforcing materials such as inorganic fibres, which are produced according to the prior art and may also be sized. Further details of the auxiliaries and additives mentioned can be found in the specialist literature, for example J. H. Saunders, K. C. Frisch: “High Polymers”, volume XVI, Polyurethanes, parts 1 and 2, Interscience Publishers 1962 and 1964, R. Gächter, H. Müller (eds.): Taschenbuch der Kunststoff-Additive [Handbook of Plastics Additives], 3rd edition, Hanser Verlag, Munich 1989, or DE-A 29 01 774. Also suitable for incorporation are standard plasticizers such as phosphates, adipates, sebacates and alkylsulphonic esters. It is likewise possible to use small amounts of customary monofunctional compounds as well, for example as chain terminators or demoulding aids. Examples include alcohols such as octanol and stearyl alcohol or amines such as butylamine and stearylamine.

For preparation of the TPUs, the formation components can be reacted, optionally in the presence of catalysts, auxiliaries and additives, in such amounts that the equivalents ratio of NCO groups to the sum total of the NCO-reactive groups, especially the OH groups of components B), C) and D), is 0.9:1.0 to 1.2:1.0, preferably 0.95:1.0 to 1.10:1.0.

According to the invention, the TPUs contain component G) in an amount of 0.02% to 3% by weight, preferably 0.02% to 1.0% by weight, based on the overall thermoplastic polyurethane. This comprises specific waxes. The water vapour permeability of the TPUs used in accordance with the invention decreases by not more than 10% after ageing at 70° C. over 24 hours.

Suitable components G) are, for example, maleic anhydride-grafted polyolefins, preferably maleic anhydride-grafted polyethylenes. Likewise useful are diesters of branched diols which may contain further hydroxyl groups with mixtures of linear or branched, saturated or unsaturated mono- and dicarboxylic acids, where the linear or branched, saturated or unsaturated mono- and dicarboxylic acids are optionally present in a stoichiometric excess, preferably diesters of adipic acid, oleic acid and pentaerythritol. Additionally used are mixtures of salts of linear or branched, saturated or unsaturated monocarboxylic acids and diesters of linear or branched, saturated or unsaturated monocarboxylic acids with linear diols, where the linear or branched, saturated or unsaturated monocarboxylic acids are optionally used in a stoichiometric excess. In addition, also suitable are reaction products of alkylenediamines, preferably ethylenediamine, with 12-hydroxystearic acid, reaction products of alkylenediamines, preferably ethylenediamine, with 12-hydroxystearic acid and one or more linear fatty acids, preferably stearic acid, and mixtures thereof, which may additionally also contain ethylenebisstearylamide. The components in G) are preferably mixtures of reaction products of ethylenediamine with stearic acid and of ethylenediamine with 12-hydroxystearic acid, mixtures of reaction products of ethylenediamine with stearic acid and of ethylenediamine with 12-hydroxystearic acid and stearic acid, mixtures of reaction products of ethylenediamine with 12-hydroxystearic acid and of ethylenediamine with 12-hydroxystearic acid and stearic acid, or mixtures of reaction products of ethylenediamine with stearic acid and of ethylenediamine with 12-hydroxystearic acid and of ethylenediamine with 12-hydroxystearic acid and stearic acid. The reaction can be effected in accordance with customary amidation methods in organic chemistry (cf. Houben and Weyl, Methoden der organischen Chemie [Methods of Organic Chemistry], 4th edition, Thieme since 1952, 8, 647-671). The acids may be reacted here with an equimolar amount of ethylenediamine, or they are reacted individually and then the amides formed are mixed. It is also possible to use mixtures of the waxes mentioned. In a particularly preferred execution, no montanic ester is used as component G).

As further layer(s) of the composite component, preference is given to using webs or textiles. These layers may be disposed on one or both sides of the TPU layer.

The TPUs used may be produced continuously in what is called an extruder method, for example in a multi-shaft extruder. The TPU components A), B), C) and optionally D) can be metered in simultaneously, i.e. in a one-shot method, or successively, i.e. by a prepolymer method. The prepolymer can either be initially charged batchwise or produced continuously in a portion of the extruder or in a separate upstream prepolymer unit.

The waxes G) can be metered continuously into the TPU reaction in the extruder, preferably in the first extruder housing. The metered addition is effected either at room temperature in the solid state or in liquid form. However, it is also possible to meter the waxes into the previously produced TPU which has been melted again in an extruder and to compound them. In a further variant, they can be mixed homogeneously into the polyol component prior to the reaction, preferably at temperatures of 70 to 120° C., and be metered into the remaining components together therewith.

The TPUs used for production of the composite components according to the invention have excellent processing characteristics.

The TPUs used can be used to produce films and foils or coatings having high homogeneity from the melt. These films and foils or coatings have a low tendency to stick and very good separation characteristics.

The flat composite components produced with the TPUs can be used to produce roofing underlayment and exterior underlayment.

The invention is to be illustrated in more detail by the examples which follow.

### EXAMPLES

TPU Preparation

For experiments 1 to 16, a reaction vessel was initially charged with 100 parts by weight of polytetrahydrofuran (Terathane® 2000 (OH number: 56 mg KOH/g, poly(tetrahydrofuran)); BASF SE, Ludwigshafen, DE) having a temperature of 190° C., in which 0.33 part by weight of Irganox® 1010 (BASF SE, Ludwigshafen, DE) and 0.4 part by weight of the particular wax 1 to 6 (except for wax 2:0.8 part by weight) had been dissolved. Then 5.5 parts by weight of butane-1,4-diol (BASF SE, Ludwigshafen, DE), 27.8 parts by weight of diphenylmethane 4,4′-diisocyanate at 60° C. (Desmodur® 44 M; Bayer MaterialScience AG, Leverkusen, DE) and 50 ppm of tin di(2-ethylhexanoate) were added while stirring, and the overall reaction mixture was stirred vigorously for about 30 seconds. Subsequently, the viscous reaction mixture was poured onto a coated metal sheet and heat-treated at 80° C. for a further 30 minutes. The cast sheets obtained were cut and pelletized.

Comparative examples 17 to 20 were produced in a continuous TPU reaction in a tubular mixer/extruder (Werner/Pfleiderer ZSK 120 extruder) by the known prepolymer method, as described in example 1 of EP-A 571 828: 73.5 parts by weight of polytetrahydrofuran (Terathane® 2000 (OH number: 56 mg KOH/g, poly(tetrahydrofuran)); BASF SE, Ludwigshafen, DE), 0.24 part by weight of Irganox° 1010 (BASF SE, Ludwigshafen, DE), 0.51 part by weight of Tinuvin® 328 (BASF SE, Ludwigshafen, DE), 0.3 part by weight of Tinuvin® 622 (BASF SE, Ludwigshafen, DE), 0.01 part by weight of KL3-2049 stabilizer, 0.4 or 0.8 part by weight of wax 1 or 2, 4 parts by weight of butane-1,4-diol (BASF SE, Ludwigshafen, DE), 20.3 parts by weight of diphenylmethane 4,4′-diisocyanate (Desmodur® 44 M; Bayer MaterialScience AG, Leverkusen, DE) and 250 ppm of tin di(2-ethylhexanoate). The housing temperatures of the 13 housings were 70° C. to 240° C. The speed of the screw was set to 210 rpm. The total metering rate was 990 kg/h. The TPU was extruded as a molten strand, cooled in water and pelletized.

Waxes used:

Wax 1=Loxamid® 3324 (N,N′-ethylenebisstearylamide; Cognis Oleochemicals GmbH, Düsseldorf, DE)

Wax 2=Licowax® E (montanic esters (C24-C34, dihydric alcohol); Clamant, Frankfurt, DE)

Wax 3=Licolub® FA6 (amide wax formed from ethylenediamine/12-hydroxystearic acid/stearic acid; Clariant, Gersthofen, DE)

Wax 4=Loxiol® G78 (calcium soaps and fatty acid esters (acid number <12); Cognis Oleochemicals GmbH, Düsseldorf, DE)

Wax 5=PU1747 (adipic acid/oleic acid/pentaerythritol ester (acid number <2; OH number 51); Bayer MaterialScience AG, Leverkusen, DE)

Wax 6=Licocene® PEMA4221 (maleic anhydride-grafted polyethylene; Clariant, Frankfurt, DE)

TPU Film Production

The pelletized TPU materials 1 to 20 were each melted in a single-shaft extruder (Brabender Plasticorder PL 2100-6 30/25D single-shaft extruder) (metering rate about 3 kg/h; 185-215° C.) and extruded through a slot die to give a flat film in each case.

Measurement of water vapour permeability (WVP) of the composite component by measuring the WVP of the TPU films used

The water vapour permeability (WVP) of the films produced was determined by the following two methods:

A) to ISO 15106-1 (85% air humidity, 23° C., set of conditions D, Goretex standard 2200 g/m²/d), sample diameter 90 mm,

B) based on DIN 53122 (storage of the films which have been tensioned and fixed over a 50 ml vessel filled with 40 g of silica gel granules (diameter 1-3 mm, with indicator) which have been baked at 130° C. for 12 h beforehand, over saturated aqueous potassium chloride solution (air humidity about 85%) in a desiccator at room temperature, determination of weight every 2 h until the increase in weight is constant (6-8 h)), sample diameter 46.5 mm.

To determine the WVP ageing, the films produced were first placed in an oven at 70° C. for 24 h and then the WVP was determined by the methods described above.

TABLE 1
WVP and WVP after ageing by method A)

| | | | Film | | | WVP |
|---|---|---|---|---|---|---|
| | | | thick- | | WVP | after |
| | Wax | | ness | | after | ageing |
| | [pts. | Heat | approx. | WVP | ageing | [%], WVP |
| Film | by wt.] | treatment | [μm] | [g/m²/d] | [g/m²/d] | as 100% |
| 1* | 1 | none | 230 | 245 | | |
| | 0.4 | | | | | |
| 2* | 1 | 24 h 70° C. | 250 | | 129 | 53 |
| | 0.4 | | | | | |
| 3* | 2 | none | 230 | 210 | | |
| | 0.8 | | | | | |
| 4* | 2 | 24 h 70° C. | 250 | | 138 | 66 |
| | 0.8 | | | | | |
| 5 | 3 | none | 250 | 226 | | |
| | 0.4 | | | | | |
| 6 | 3 | 24 h 70° C. | 260 | | 224 | 99 |
| | 0.4 | | | | | |
| 7* | none | none | 200 | 258 | | |
| | 0 | | | | | |
| 8* | none | 24 h 70° C. | 220 | | 268 | 104 |
| | 0 | | | | | |

*comparative examples

TABLE 2
WVP and WVP after ageing by method B)

| | | | Film | | | WVP |
|---|---|---|---|---|---|---|
| | Wax | | thick- | | WVP | after |
| | No. | | ness | | after | ageing |
| | [pts. | Heat | approx. | WVP | ageing | [%], WVP |
| Film | by wt.] | treatment | [μm] | [g/m²/d] | [g/m²/d] | as 100% |
| 9 | 3 | none | 60 | 276 | | |
| | 0.4 | | | | | |
| 10 | 3 | 24 h 70° C. | 60 | | 261 | 95 |
| | 0.4 | | | | | |
| 11 | 4 | none | 100 | 176 | | |
| | 0.4 | | | | | |
| 12 | 4 | 24 h 70° C. | 90 | | 179 | 102 |
| | 0.4 | | | | | |
| 13 | 5 | none | 60 | 293 | | |
| | 0.4 | | | | | |
| 14 | 5 | 24 h 70° C. | 50 | | 298 | 102 |
| | 0.4 | | | | | |
| 15 | 6 | none | 70 | 253 | | |
| | 0.4 | | | | | |
| 16 | 6 | 24 h 70° C. | 70 | | 244 | 96 |
| | 0.4 | | | | | |
| 17* | 1 | none | 70 | 328 | | |
| | 0.4 | | | | | |
| 18* | 1 | 24 h 70° C. | 70 | | 285 | 87 |
| | 0.4 | | | | | |
| 19* | 2 | none | 80 | 289 | | |
| | 0.8 | | | | | |
| 20* | 2 | 24 h 70° C. | 80 | | 103 | 36 |
| | 0.8 | | | | | |

*comparative examples

The results show that only in the case of use of waxes 3 to 6 used in accordance with the invention did the water vapour permeability of the thermoplastic polyurethane films remain virtually unchanged after ageing at 70° C. over 24 hours. In addition, the wax-free comparative examples 7 and 8, which likewise did not show any drop in water vapour permeability after ageing, demonstrate that the different degrees of loss of water vapour permeability after ageing in the case of the wax-containing examples 1 to 6 and 9 to 20 were caused not by the polymer matrix but by the waxes alone. The wax-free TPUs, however, have distinct disadvantages in terms of producibility and processing characteristics, and are therefore unsuitable for the production of composite components.

1. A water vapour-permeable, flat composite component comprising at least two layers, wherein at least one layer comprises a thermoplastic polyurethane comprising a reaction product of component comprising:
A) one or more organic diisocyanates;
B) one or more components each having two hydroxyl groups and a number-average molecular weight of 60 to 490 g/mol as chain extenders;
C) one or more linear aliphatic hydroxyl-terminated polyether polyols each having number-average molecular weights of 500 to 5000 g/mol and a number-average functionality of component C) of 1.8 to 2.5;
wherein the molar ratio of the NCO groups in A) to the isocyanate-reactive groups in components B) and C) is 0.9:1 to 1.2:1;
wherein the reaction is effected with addition of:
G) 0.02% to 3% by weight, based on the overall weight of the thermoplastic polyurethane, of at least one component selected from the group consisting of:
i) maleic anhydride-grafted polyolefins;
ii) diesters of branched diols which may contain further hydroxyl groups with mixtures of linear or branched, saturated or unsaturated mono- and dicarboxylic acids;
iii) mixtures of salts of linear or branched, saturated or unsaturated monocarboxylic acids and diesters of linear or branched, saturated or unsaturated monocarboxylic acids with linear diols;
iv) reaction products of alkylenediamines, with 12-hydroxystearic acid; and
v) reaction products of alkylenediamines with 12-hydroxystearic acid and one or more linear fatty acids;
and wherein the water vapour permeability of the layer of the thermoplastic polyurethane decreases by not more than 10% after ageing at 70° C. over 24 hours.

2. The flat composite component according to claim 1, wherein the diisocyanate A) is selected from the group consisting of: diphenylmethane 4,4′-diisocyanate, isophorone diisocyanate, hexamethylene 1,6-diisocyanate, naphthylene 1,5-diisocyanate dicyclohexylmethane 4,4′-diisocyanate and a mixture of any thereof.

3. The flat composite component according to claim 1, wherein the chain extender B) is an aliphatic diol chain extender.

4. The flat composite component according to claim 1, wherein the chain extenders B) comprise at least two aliphatic diol chain extenders.

5. The flat composite component according to claim 4, wherein the chain extenders B) comprise at least two compounds selected from the group consisting of: ethanediol, propanediol, butanediol, hexanediol, 1,4-di(beta-hydroxyethyl)hydroquinone, and 1,4-di(beta-hydroxyethyl)bisphenol A).

6. The flat composite component according to claim 1, wherein the polyether polyols in C) comprise one or more compounds selected from the group consisting of: poly(ethylene glycols), poly(1,2-propylene glycols), poly(1,3-propylene glycols), poly(tetramethylene glycols) and polyether polyols formed from ethylene oxide units and propylene oxide units.

7. The flat composite component according to claim 1, wherein the polyester polyols in D) are aliphatic polyester polyols.

8. The flat composite component according to claim 1, wherein the at least one component in G) is present in an amount of 0.02%-1.0% by weight, based on the overall weight of the thermoplastic polyurethane.

9. The flat composite component according to claim 1, wherein the component in G) comprises component (i), and wherein component (i) comprises maleic anhydride-grafted polyethylenes.

10. The flat composite component according to claim 1, wherein the component in G) comprises component (ii), and wherein component (ii) comprises diesters of adipic acid, oleic acid and pentaerythritol.

11. The flat composite component according to claim 1, wherein the component in G) is selected from the group consisting of:
mixtures of reaction products of ethylenediamine with stearic acid and of ethylenediamine with 12-hydroxystearic acid;
mixtures of reaction products of ethylenediamine with stearic acid and of ethylenediamine with 12-hydroxystearic acid and stearic acid;
mixtures of reaction products of ethylenediamine with 12-hydroxystearic acid and of ethylenediamine with 12-hydroxystearic acid and stearic acid;
mixtures of reaction products of ethylenediamine with stearic acid and of ethylenediamine with 12-hydroxystearic acid and of ethylenediamine with 12-hydroxystearic acid and stearic acid; and
combinations of any of the mixtures thereof.

12. The flat composite component according to claim 1, wherein the component in G) does not comprise a montanic ester.

13. A roofing underlayment or an exterior underlayment comprising the flat composite component according to claim 1.

14. The flat composite component according to claim 1, wherein the reaction components further comprise:
D) polyester polyols each having number-average molecular weights of 500-5000 g/mol and a number-average functionality of component D) of 1.8 to 2.5.

15. The flat composite component according to claim 1, wherein the molar ratio of the NCO groups in A) to the isocyanate-reactive groups in components B) and C) is 0.9:1 to 1.2:1.

16. The flat composite component according to claim 15, wherein the molar ratio of the NCO groups in A) to the isocyanate-reactive groups in components B), C), and D) is 0.9:1 to 1.2:1.

17. The flat composite component according to claim 1, wherein the reaction is conducted in the presence of:
E) catalysts.

18. The flat composite component according to claim 1, wherein the reaction is with an addition of:
F) auxiliaries and/or additives.

19. The flat composite component according to claim 1, wherein component G) is at least one component selected from the group consisting of:
ii) diesters of branched diols which may contain further hydroxyl groups with mixtures of linear or branched, saturated or unsaturated mono- and dicarboxylic acids used in a stoichiometric excess;
iii) mixtures of salts of linear or branched, saturated or unsaturated monocarboxylic acids and diesters of linear or branched, saturated or unsaturated monocarboxylic acids with linear diols used in a stoichiometric excess;
iv) reaction products of ethylenediamine with 12-hydroxystearic acid; and
v) reaction products of ethylenediamine with 12-hydroxystearic acid and one or more linear fatty acids.
